(19) United States
(12) Patent Application Publication
(10) Pub. No.: US 2010/0050179 A1
(43) Pub. Date: Feb. 25, 2010

(54) LAYERED CAPACITY DRIVEN PROVISIONING IN DISTRIBUTED ENVIRONMENTS

(76) Inventors: Ajay Mohindra, Yorktown Heights, NY (US); Anindya Neogi, New Delhi (IN); Balaji Viswanathan, New Delhi (IN)

Correspondence Address: RYAN, MASON & LEWIS, LLP, 90 FOREST AVENUE, LOCUST VALLEY, NY, 11560, US

(21) Appl. No.: 12/196,386

(22) Filed: Aug. 22, 2008

(51) Int. Cl. G06F 9/50; G06F 15/16; G06F 15/173; G06F 17/00

(52) U.S. Cl. 718/104; 707/102; 707/E17.001

(57) ABSTRACT

Techniques are disclosed for providing mapping of application components to a set of resources in a distributed environment using capacity driven provisioning using a layered approach. By way of example, a method for allocating resources to an application comprises the following steps. A first data structure is obtained representing a post order traversal of a dependency graph for the application and associated containers with capacity requirements. A second data structure is obtained representing a set of resources, and associated with each resource is a tuple representing available capacity. A mapping of the dependency graph data structure to the resource set is generated based on the available capacity such that resources of the set of resources are allocated to the application.

### FIELD OF THE INVENTION

The present invention relates to computer network management and, more particularly, to techniques for providing mapping of application components to a set of resources in a distributed environment using capacity driven provisioning using a layered approach.

### BACKGROUND OF THE INVENTION

With the increasing popularity of Service Oriented Architecture (SOA) based approaches for designing and deploying applications, there is a need to map and deploy composite enterprise applications across a set of resources in a distributed environment. The process of mapping involves verifying that requisite software needed to run the application components is preinstalled on the resources, and the physical resources assigned to the software components have the required capacity to host the software components without compromising the service level agreements (SLA) associated with the composite application. Further, each prerequisite software component could have additional dependencies that need to be met before the software component itself can be installed. For example, these dependencies comprise dependencies on systems libraries, third-part software, and/or operating system components. For example, installation of IBM WebSphere Portal Server requires the installation of IBM WebSphere Application Server.

Existing approaches to the mapping the composite enterprise applications in a distributed environment take into account raw physical capacity (e.g., memory, network bandwidth, central processing unit). The main weakness of these approaches is that they fail to take into account software component specific dependencies in making the mapping decision.

### SUMMARY OF THE INVENTION

Principles of the invention provide techniques for providing mapping of application components to a set of resources in a distributed environment using capacity driven provisioning using a layered approach.

By way of example, in one embodiment, a method for representing available capacity of a computing resource as a tuple comprises the following steps. A set of one or more software and hardware components installed on the computing resource is obtained. The available capacity for each one of the set of one or more software and hardware components that can act as a container for other components is determined. A tuple is created representing the collection of available capacities for each container. The container may include at least one of: (i) one or more physical resources; (ii) one or more virtual resources; and (iii) one or more nested software containers.

By way of further example, in another embodiment, a method for allocating resources to an application comprises the following steps. A first data structure is obtained representing a post order traversal of a dependency graph for the application and associated containers with capacity requirements. A second data structure is obtained representing a set of resources, and associated with each resource is a tuple representing available capacity. A mapping of the dependency graph data structure to the resource set is generated based on the available capacity such that resources of the set of resources are allocated to the application.

These and other objects, features, and advantages of the present invention will become apparent from the following detailed description of illustrative embodiments thereof, which is to be read in connection with the accompanying drawings.

### BRIEF DESCRIPTION OF THE DRAWINGS

FIG. 1 depicts a pictorial representation of a network data processing system, which may be used to implement an exemplary embodiment of the present invention.

FIG. 2 is a block diagram of a data processing system, which may be used to implement an exemplary embodiment of the present invention.

FIG. 3 depicts a schematic representation of a service delivery environment, which may be used to implement an exemplary embodiment of the present invention.

FIG. 4 depicts an example of a logical application structure containing a resource dependency characterization of a sample application, according to an exemplary embodiment of the present invention.

FIG. 5 shows the logical architecture of the placement controller component, according to an exemplary embodiment of the present invention.

FIG. 6 shows the steps that the placement controller takes to determine the mapping of a composite business solution (CBS) to a set of resources in a distributed environment, according to an exemplary embodiment of the present invention.

FIG. 7A shows the metadata data structure associated with each solution stored in the solution repository, according to an exemplary embodiment of the present invention.

FIG. 7B shows the requirements for each software component that can be installed, according to an exemplary embodiment of the present invention.

FIG. 8 shows the data structure that shows the maximum available capacity of each component when it is installed on a node for the first time, according to an exemplary embodiment of the present invention.

FIG. 9 shows the installed software stack and available capacities for each component stored in the deployment repository, according to an exemplary embodiment of the present invention.

### DETAILED DESCRIPTION OF PREFERRED EMBODIMENTS

Hereinafter, exemplary embodiments of the present invention will be described with reference to the accompanying drawings. It is to be understood that exemplary embodiments of the present invention described herein may be implemented in various forms of hardware, software, firmware, special purpose processors, or a combination thereof. An exemplary embodiment of the present invention may take the form of an entirely hardware embodiment, an entirely software embodiment or an embodiment containing both hardware and software elements. An exemplary embodiment may be implemented in software as an application program tangibly embodied on one or more program storage devices, such as for example, computer hard disk drives, CD-ROM (compact disk-read only memory) drives and removable media such as CDs, DVDs (digital versatile discs or digital video discs), Universal Serial Bus (USB) drives, floppy disks, diskettes and tapes, readable by a machine capable of executing the program of instructions, such as a computer. The application program may be uploaded to, and executed by, an instruction execution system, apparatus or device comprising any suitable architecture. It is to be further understood that since exemplary embodiments of the present invention depicted in the accompanying drawing figures may be implemented in software, the actual connections between the system components (or the flow of the process steps) may differ depending upon the manner in which the application is programmed.

As used herein, the phrase “computing resource” generally refers to an entity that provides compute cycles for executing software instructions. Further, as used herein, “resources” generally refer to different entities that represent hardware, software, network, disk capabilities, etc., for example, as may be required by a composite business (enterprise) solution (or CBS as explained below). That is, in illustrative terms of embodiments described below, a resource can be defined as a container that provides a capability to host a service (i.e., a solution), and a computing resource would thus provide compute capability to host the service (solution).

Furthermore, as used herein, a “software component” refers to a constituent of a solution that requires some capacity from the container hosting it. A deployed instance of a component consumes capacity from its container and in turn can acts as a container for one or more other components. A “hardware component” refers to a physical resource contributing to capacity of a computer system. As used herein, a “target” for a component would be the container in which it is hosted.

It is to be appreciated that in an illustrative real world application of principles of the invention, resource allocations determined thereby may be utilized in data centers. For example, when an application for a customer needs to be hosted at a data center, the system administrator needs to identify servers that are capable of hosting the software components of the application. If a system administrator allocates new (previously undeployed) hardware for the application, then no resource allocation needs to be done. However, a downside of this approach is that hosting costs are high when the hardware is not shared. When the system administrator needs to identify hardware from currently deployed hardware resources, then resource allocation techniques of the invention would help the system administrator to identify hardware that meets the requirements of the software application. This results in lower costs as the hardware and software is now shared across multiple customers.

By way of further example, the following are real world applications in which principles of the invention can be applied.

IBM Lotus Connections is a collaboration solution which contains multiple independent components like “Blogs,” “Profiles,” “Activities,” “Dogears” and “Communities.” These components in turn depend on services provided by other software containers like “Application Server,” “Database Server,” “Directory Server,” “Web Server.” Each of these containers have their specific attributes to define capacities, e.g., a Directory Server can define capacity in terms of number of user/group entries and their level of detail and/or the number and kind of queries per time interval it can support. Still further, a Web 2.0 Mashup application combines the services provided by two or more independent component services as an integrated service. An enterprise mashup application which combines the enterprise employee organizational information with a location/map service to provide an organizational connectivity service is an example.

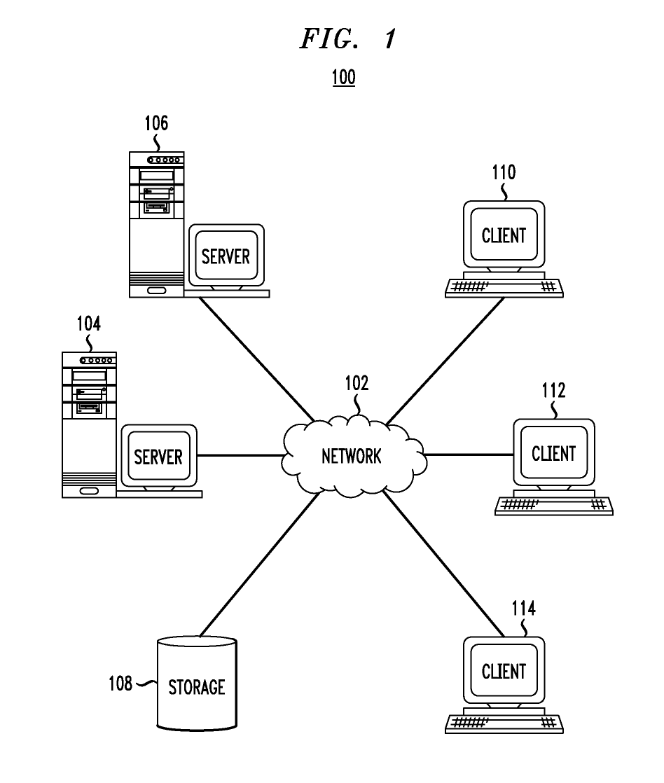

FIG. 1 depicts a pictorial representation of a network data processing system, which may be used to implement an exemplary embodiment of the present invention. Network data processing system 100 includes a network of computers, which can be implemented using any suitable computers. Network data processing system 100 may include, for example, a personal computer, workstation or mainframe. Network data processing system 100 may employ a client-server network architecture in which each computer or process on the network is either a client or a server.

Network data processing system 100 includes a network 102, which is a medium used to provide communications links between various devices and computers within network data processing system 100. Network 102 may include a variety of connections such as wires, wireless communication links, fiber optic cables, connections made through telephone and/or other communication links.

A variety of servers, clients and other devices may connect to network 102. For example, a server 104 and a server 106 may be connected to network 102, along with a storage unit 108 and clients 110, 112 and 114, as shown in FIG. 1. Storage unit 108 may include various types of storage media, such as for example, computer hard disk drives, CD-ROM drives and/or removable media such as CDs, DVDs, USB drives, floppy disks, diskettes and/or tapes. Clients 110, 112 and 114 may be, for example, personal computers and/or network computers.

Client 110 may be a personal computer. Client 110 may comprise a system unit that includes a processing unit and a memory device, a video display terminal, a keyboard, storage devices, such as floppy drives and other types of permanent or removable storage media, and a pointing device such as a mouse. Additional input devices may be included with client 110, such as for example, a joystick, touchpad, touchscreen, trackball, microphone, and the like.

Clients 110, 112 and 114 may be clients to server 104, for example. Server 104 may provide data, such as boot files, operating system images, and applications to clients 110, 112 and 114. Network data processing system 100 may include other devices not shown.

Network data processing system 100 may comprise the Internet with network 102 representing a worldwide collection of networks and gateways that use the Transmission Control Protocol/Internet Protocol (TCP/IP) suite of protocols to communicate with one another. The Internet includes a backbone of high-speed data communication lines between major nodes or host computers consisting of a multitude of commercial, governmental, educational and other computer systems that route data and messages.

Network data processing system 100 may be implemented as any suitable type of networks, such as for example, an intranet, a local area network (LAN) and/or a wide area network (WAN). The pictorial representation of network data processing elements in FIG. 1 is intended as an example, and not as an architectural limitation for embodiments of the present invention.

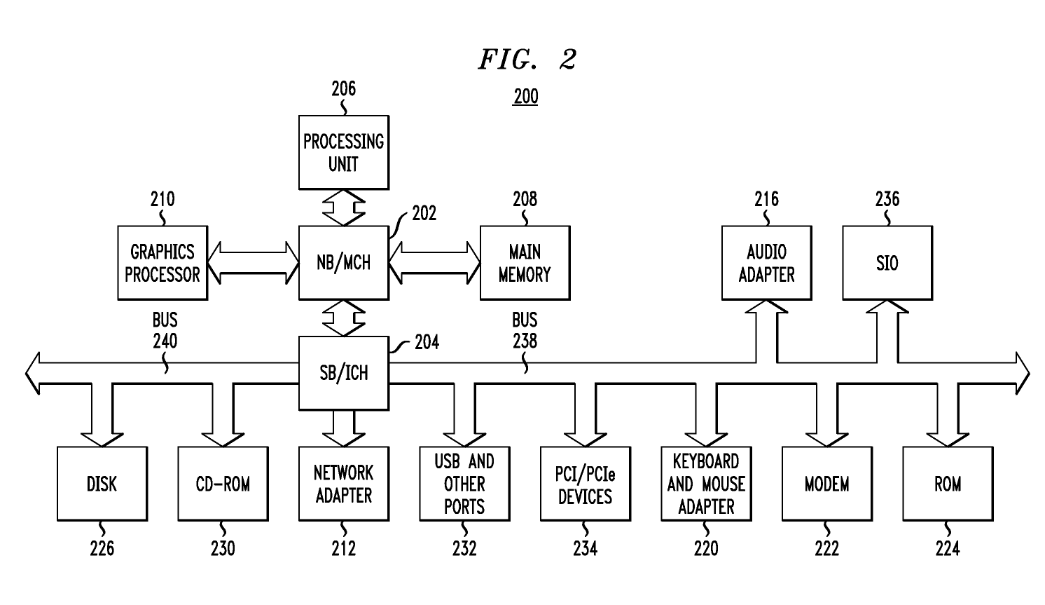

FIG. 2 is a block diagram of a data processing system, which may be used to implement an exemplary embodiment of the present invention. Data processing system 200 is an example of a computer, such as server 104 or client 110 of FIG. 1, in which computer usable code or instructions implementing processes of embodiments of the present invention may be located.

In the depicted example, data processing system 200 employs a hub architecture including a north bridge and memory controller hub (NB/MCH) 202 and a south bridge and input/output (I/O) controller hub (SB/ICH) 204. Processing unit 206 that includes one or more processors, main memory 208, and graphics processor 210 are coupled to the north bridge and memory controller hub 202. Graphics processor 210 may be coupled to the NB/MCH 202 through an accelerated graphics port (AGP). Data processing system 200 may be, for example, a symmetric multiprocessor (SMP) system including a plurality of processors in processing unit 206. Data processing system 200 may be a single processor system.

In the depicted example, local area network (LAN) adapter 212 is coupled to south bridge and I/O controller hub 204. Audio adapter 216, keyboard and mouse adapter 220, modem 222, read only memory (ROM) 224, universal serial bus (USB) ports and other communications ports 232, and PCI/PCIe (PCI Express) devices 234 are coupled to south bridge and I/O controller hub 204 through bus 238, and hard disk drive (HDD) 226 and CD-ROM drive 230 are coupled to south bridge and I/O controller hub 204 through bus 240.

Examples of PCI/PCIe devices include Ethernet adapters, add-in cards, and PC cards for notebook computers. In general, PCI uses a card bus controller while PCIe does not. ROM 224 may be, for example, a flash binary input/output system (BIOS). Hard disk drive 226 and CD-ROM drive 230 may use, for example, an integrated drive electronics (IDE) or serial advanced technology attachment (SATA) interface. A super I/O (SIO) device 236 may be coupled to south bridge and I/O controller hub 204.

An operating system, which may run on processing unit 206, coordinates and provides control of various components within data processing system 200. For example, the operating system may be a commercially available operating system such as Microsoft® Windows® XP (Microsoft and Windows are trademarks or registered trademarks of Microsoft Corporation in the United States, other countries, or both). An object-oriented programming system, such as the Java™ programming system, may run in conjunction with the operating system and provides calls to the operating system from Java programs or applications executing on data processing system 200 (Java and all Java-based marks are trademarks or registered trademarks of Sun Microsystems, Inc. in the United States, other countries, or both).

Instructions for the operating system, object-oriented programming system, applications and/or programs of instructions are located on storage devices, such as for example, hard disk drive 226, and may be loaded into main memory 208 for execution by processing unit 206. Processes of exemplary embodiments of the present invention may be performed by processing unit 206 using computer usable program code, which may be located in a memory, such as for example, main memory 208, read only memory 224 or in one or more peripheral devices.

It will be appreciated that the hardware depicted in FIGS. 1 and 2 may vary depending on the implementation. Other internal hardware or peripheral devices, such as flash memory, equivalent non-volatile memory, or optical disk drives and the like, may be used in addition to or in place of the depicted hardware. Processes of embodiments of the present invention may be applied to a multiprocessor data processing system.

Data processing system 200 may take various forms. For example, data processing system 200 may be a tablet computer, laptop computer, or telephone device. Data processing system 200 may be, for example, a personal digital assistant (PDA), which may be configured with flash memory to provide non-volatile memory for storing operating system files and/or user-generated data. A bus system within data processing system 200 may include one or more buses, such as a system bus, an I/O bus and PCI bus. It is to be understood that the bus system may be implemented using any type of communications fabric or architecture that provides for a transfer of data between different components or devices coupled to the fabric or architecture. A communications unit may include one or more devices used to transmit and receive data, such as modem 222 or network adapter 212. A memory may be, for example, main memory 208, ROM 224 or a cache such as found in north bridge and memory controller hub 202. A processing unit 206 may include one or more processors or CPUs.

Methods for automated provisioning according to exemplary embodiments of the present invention may be performed in a data processing system such as data processing system 100 shown in FIG. 1 or data processing system 200 shown in FIG. 2.

It is to be understood that a program storage device can be any medium that can contain, store, or be used to transport a program of instructions for use by or in connection with an instruction execution system, apparatus or device. The medium can be, for example, an electronic, magnetic, optical, or semiconductor system (or apparatus or device) or a propagation medium. Examples of a program storage device include a semiconductor or solid state memory, magnetic tape, removable computer diskettes, RAM (random access memory), ROM (read-only memory), rigid magnetic disks, and optical disks such as a CD-ROM, CD-R/W and DVD.

A data processing system suitable for storing and/or executing a program of instructions may include one or more processors coupled directly or indirectly to memory elements through a system bus. The memory elements can include local memory employed during actual execution of the program code, bulk storage, and cache memories that provide temporary storage of at least some program code to reduce the number of times code must be retrieved from bulk storage during execution.

Data processing system 200 may include input/output (I/O) devices, such as for example, keyboards, displays and pointing devices, which can be coupled to the system either directly or through intervening I/O controllers. Network adapters may also be coupled to the system to enable the data processing system to become coupled to other data processing systems or remote printers or storage devices through intervening private or public networks. Network adapters include, but are not limited to, modems, cable modem and Ethernet cards.

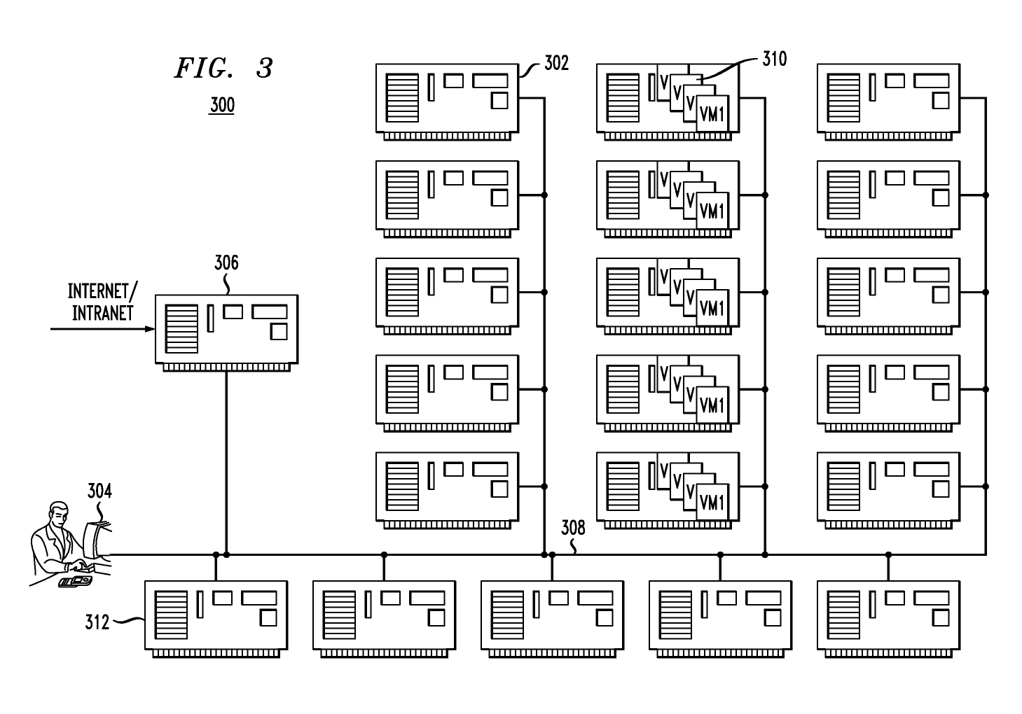

FIG. 3 depicts a schematic representation of a service delivery environment, which may be used to implement an exemplary embodiment of the present invention. Referring to FIG. 3, service delivery environment 300 includes a farm of physical servers 302, DMZ (demilitarized zone) 306 and management servers 312. The term “demilitarized zone” or acronym “DMZ” refers to a network area that sits between an organization's internal network and an external network, such as the Internet.

User requests from the Internet or an intranet are received by a router device. For example, a router device may be located within the DMZ 306. The router device may be implemented by a reverse proxy, such as IBM's WebSeal product.

User requests may be directed via network 308 to a provisioning solution that is hosted on a collection of real (physical) or virtual machines 310 running on the server farm 302. Management servers 312 that may be used to manage the server farm 302 are coupled via network 308 to the physical servers 302. The management servers 312 may be used by system administrators 304 to manage and monitor the server farm. Software running on the management servers 312 may assist with various tasks such as software metering, application provisioning, monitoring all (or selected) applications, and problem determination of the server farm.

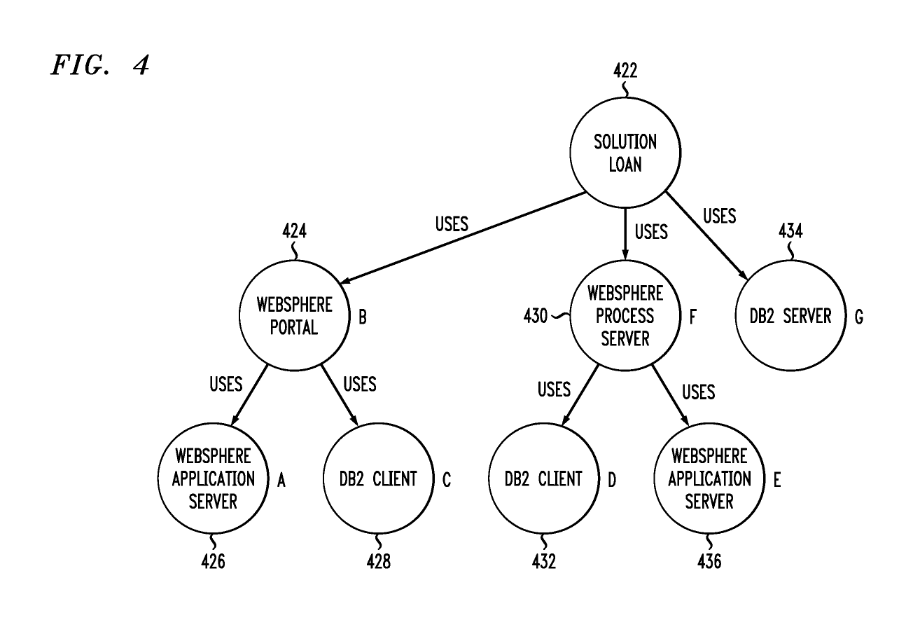

FIG. 4 depicts an example of a logical application structure containing a resource dependency characterization of a sample application, according to an exemplary embodiment of the present invention. Referring to FIG. 4, the example logical application structure is a dependency graph containing resource dependency characteristics of the sample application. However, it is to be understood that any suitable logical application structure may be employed.

A dependency graph may be expressed as an eXtensible Markup Language (XML) file that highlights the relationships and dependencies between different components. In the example depicted in FIG. 4, the “Loan Solution” 422 largely depends on the availability of three components, WebSphere Portal Server 424, WebSphere Process Server 430 and DB2 server 434. The WebSphere Portal Server 424 depends on the availability of WebSphere Application Server 426 and DB2 client 428. The WebSphere Process Server depends upon DB2 client 432 and WebSphere Application Server 436.

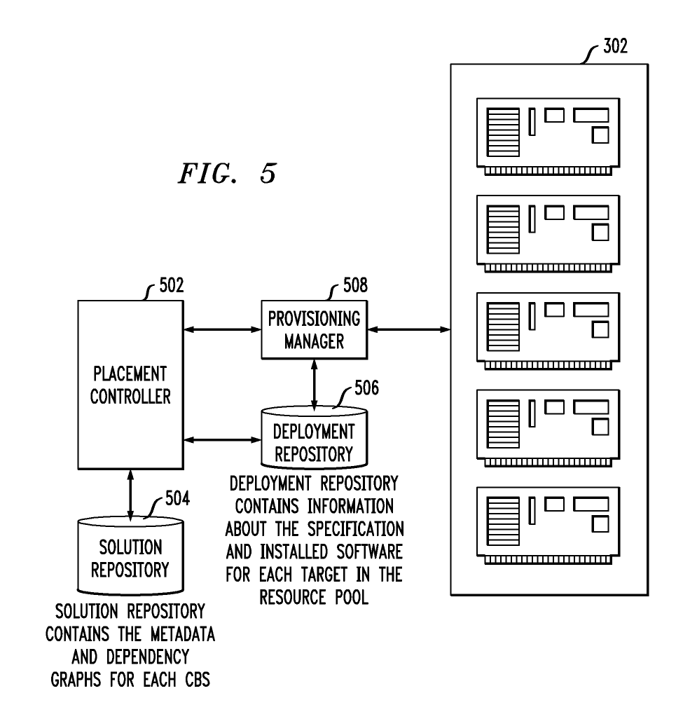

FIG. 5 shows the logical architecture of a placement controller component. The architecture consists of a solution repository (504) and a deployment repository (506). The solution repository contains metadata and dependency graphs for each composite enterprise solution. The metadata comprises required capacity needs of each software components in the solution dependency graph. The deployment repository comprises mappings of software components deployed to physical resources, along with total available capacity associated with each resource. Also shown is provisioning manager 508, discussed below.

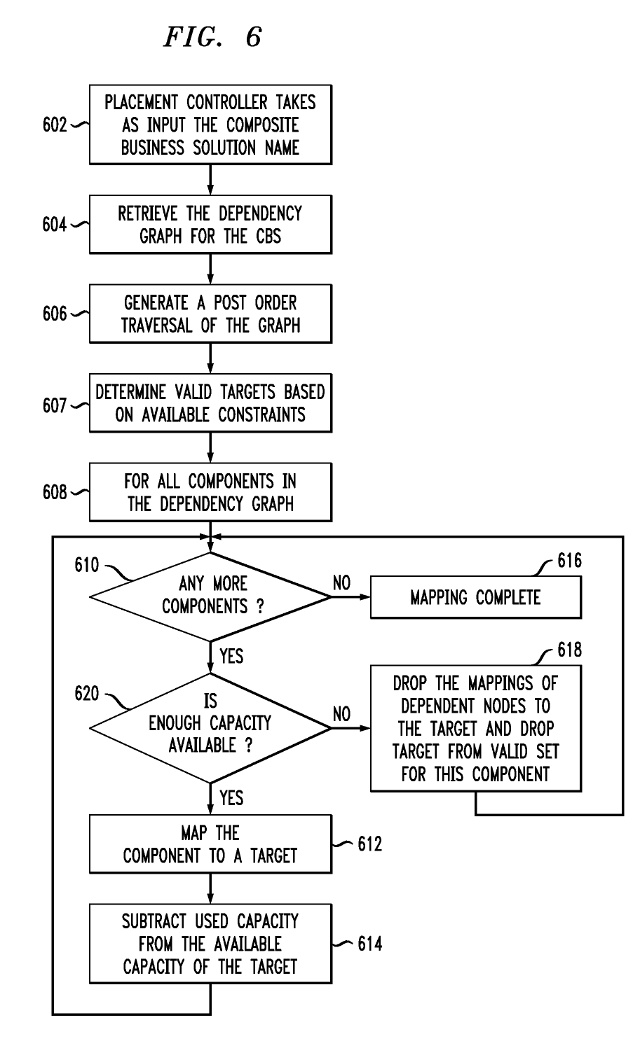

FIG. 6 shows the steps that the placement controller takes to determine the mapping of a composite business (enterprise) solution (CBS) to a set of computing resources in a distributed environment. In step 602, the placement controller takes in as input the name of the CBS. In step 604, the placement controller retrieves the dependency graph for the CBS from the solution repository. The dependency graph is stored as part of the CBS metadata in the solution repository. The placement controller generates a post order traversal of the dependency graph in step 606. Using the information in the deployment repository, the placement controller retrieves the specification for a set of candidate targets for the CBS. The specification is a representation of available capacities for each software and hardware component available on a specific target.

In step 608, the placement controller iterates through all the components in the post order representation of the dependency graph, and maps a component if the available capacity for that software component is more than the required capacity for the CBS component (612). In step 614, the required capacity is subtracted from the available capacity of the software components. If enough capacity is not available the in step 620, then the mappings of dependent components is dropped and the target is removed from consideration for this CBS component. In step 616, the algorithm completes with the recommended mapping when all the CBS components are mapped to valid targets. It is to be appreciated that the term “valid” generally refers to the condition that the identified targets meet and satisfy the requirements (i.e., capacity, CPU, etc.) of the CBS components.

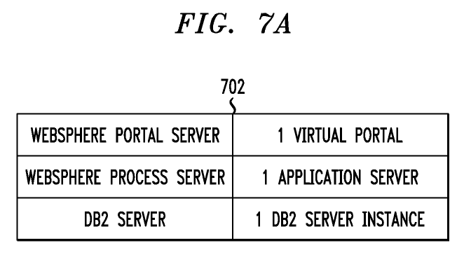

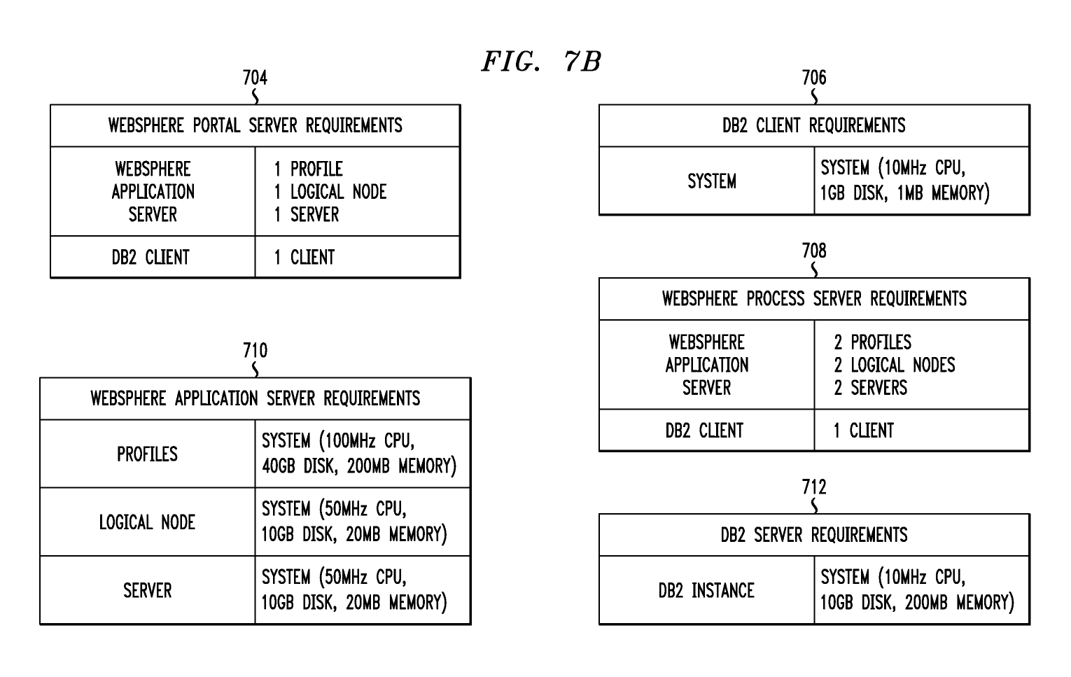

FIG. 7A shows the metadata data structure associated with each solution stored in the solution repository (702). The metadata represents the requirements for installing an instance of the solution component.

FIG. 7B shows the requirements for each software component that can be installed. Each data structure (table 704, 706, 708, 710 and 712) represents the dependency of each component on other components.

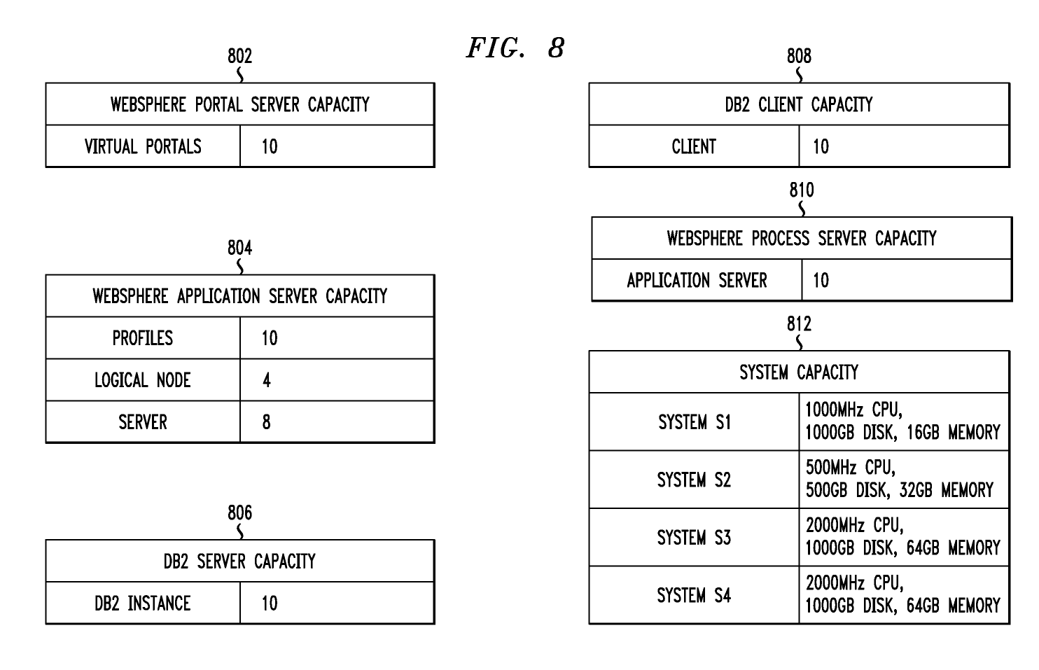

FIG. 8 shows the data structures (tables 802, 804, 806, 808, 810 and 812) that show the maximum available capacity of each component when it is installed on a node for the first time. These data structures are stored in the deployment repository. The placement controller subtracts required capacity from the maximum available capacity each time a software component is mapped to a resource.

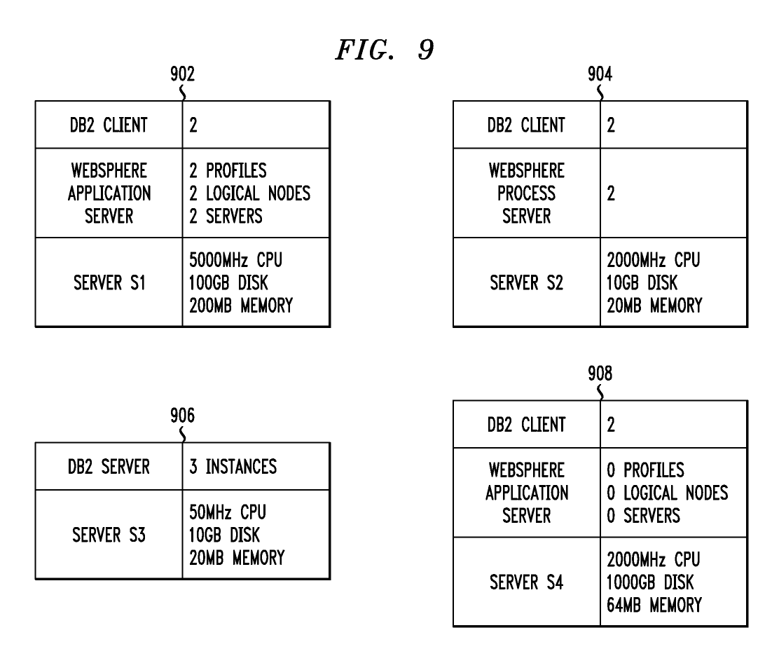

In accordance with tables 902, 904, 906 and 908, FIG. 9 shows the installed software stack and available capacities for each component stored in the deployment repository. As an example, we map the composite application of FIG. 4 using the steps outlined in FIG. 6. The post order traversal of the dependency graph yield sequence ACBDEFG, where letters A through G represent the nodes in the dependency graph of FIG. 4. The resource pool has four servers: S1, S2, S3, and S4. The algorithm identifies starts with the first node in the postorder traversal and maps A to server S1 as it meets the requirements of A. Using a similar logic, the algorithm also maps node C to server S1. Since the dependency and available capacity requirements of node B are satisfied, the algorithm maps node B to server S1. Having mapped nodes A, C, and B to server S1, the placement controller decrements the available capacity for server S1 by the sum total of requirements of node A, C, and B. Next, the placement controller considers node D, and narrows the target resources to S1, S2, S3 as all have adequate capacities available to meet the requirements. For example, if the placement controller selects S1 for node D, it would fail to map node E on S1 as there is no sufficient capacity available on server S1 to satisfy the needs of WebSphere App Server. The algorithm would then remap nodes D and E to server S2, and node F to server S2. Lastly, node G is mapped to S3 as it has the DB2 Server installed and sufficient capacity is available to host the DB2 server. Now that all the nodes are mapped to resources, the placement controller completes the steps. Any software components that are not installed on target resources are automatically installed by the provisioning manager based on the recommended mappings.

Although illustrative embodiments of the present invention have been described herein with reference to the accompanying drawings, it is to be understood that the invention is not limited to those precise embodiments, and that various other changes and modifications may be made by one skilled in the art without departing from the scope or spirit of the invention.

What is claimed is:

1. A method for representing available capacity of a computing resource as a tuple, comprising the steps of:
obtaining a set of one or more software and hardware components installed on the computing resource;
determining the available capacity for each one of the set of one or more software and hardware component that can act as a container for other components; and
creating a tuple representing the collection of available capacities for each container.

2. The method of claim 1, wherein each container comprises at least one of a physical resource, a virtual resource, and one or more nested software containers.

3. An article of manufacture comprising a computer readable storage medium including one or more computer programs which, when loaded and executed by a computer system, implement the steps of claim 1.

4. A method for allocating resources to an application, comprising the steps of:
obtaining a first data structure representing a post order traversal of a dependency graph for the application and associated containers with capacity requirements;
obtaining a second data structure representing a set of resources, and associated with each resource is a tuple representing available capacity; and
generating a mapping of the dependency graph data structure to the resource set based on the available capacity such that resources of the set of resources are allocated to the application.

5. The method of claim 4, wherein the dependency graph is stored in and retrieved from a solutions repository, and the retrieved dependency graph is associated with a given solution stored in the solutions repository.

6. The method of claim 5, wherein the post order traversal is generated from the retrieved dependency graph associated with the given solution.

7. The method of claim 6, wherein the second data structure representing the set of resources is stored in and retrieved from a deployment repository.

8. The method of claim 7, wherein each resource of the set of resources is traversed in accordance with the post order representation of the dependency graph, and a given resource is mapped when the available capacity for that resource is more than the required capacity for the given solution.

9. The method of claim 8, further comprising the step of subtracting the required capacity from the available capacity of the given resource.

10. The method of claim 9, wherein when enough capacity is not available for the given resource, consideration of the given resource and any dependent components is dropped for the given solution.

11. An article of manufacture comprising a computer readable storage medium including one or more computer programs which, when loaded and executed by a computer system, implement the steps of claim 4.

12. Apparatus for allocating resources to an application, comprising:
a memory; and
at least one processor coupled to the memory and configured to obtain a first data structure representing a post order traversal of a dependency graph for the application and associated containers with capacity requirements, obtain a second data structure representing a set of resources, and associated with each resource is a tuple representing available capacity, and generate a mapping of the dependency graph data structure to the resource set based on the available capacity such that resources of the set of resources are allocated to the application.

13. The apparatus of claim 12, wherein the dependency graph is stored in and retrieved from a solutions repository, and the retrieved dependency graph is associated with a given solution stored in the solutions repository.

14. The apparatus of claim 13, wherein the post order traversal is generated from the retrieved dependency graph associated with the given solution.

15. The apparatus of claim 14, wherein the second data structure representing the set of resources is stored in and retrieved from a deployment repository.

16. The apparatus of claim 15, wherein each resource of the set of resources is traversed in accordance with the post order representation of the dependency graph, and a given resource is mapped when the available capacity for that resource is more than the required capacity for the given solution.

17. The apparatus of claim 16, wherein the at least one processor is further configured to subtract the required capacity from the available capacity of the given resource.

18. The apparatus of claim 17, wherein when enough capacity is not available for the given resource, consideration of the given resource and any dependent components is dropped for the given solution.

19. Apparatus for representing available capacity of a computing resource as a tuple, comprising:
a memory; and
at least one processor coupled to the memory and configured to obtain a set of one or more software and hardware components installed on the computing resource, determine the available capacity for each one of the set of one or more software and hardware component that can act as a container for other components, and create a tuple representing the collection of available capacities for each container.

20. The apparatus of claim 19, wherein each container comprises at least one of a physical resource, a virtual resource, and one or more nested software containers.
